(19) United States
(12) Patent Application Publication
(10) Pub. No.: US 2019/0299956 A1
(43) Pub. Date: Oct. 3, 2019

(54) BRAKING SYSTEM FOR AUTONOMOUS VEHICLE

(71) Applicant: VEONEER US INC., Southfield, MI (US)

(72) Inventors: Stephen Lewis Pudvay, Howell, MI (US); William Alan Szabela, Brookston, IN (US)

(21) Appl. No.: 15/939,905

(22) Filed: Mar. 29, 2018

(51) Int. Cl. B60T 13/74; B60T 13/68

(52) U.S. Cl. CPC B60T 13/745; B60T 2270/413; B60T 13/686

(57) ABSTRACT

An apparatus comprising a first circuit module and a second circuit module. The first circuit module may be configured to communicate with a vehicle over a first bus. The first circuit module (i) generates one or more first brake control signals in response to one or more command inputs and (ii) is powered by a first power source. The first brake control signals provide control of hydraulic flow and pressure applied to a first one or more brake calipers in a vehicle. The second circuit module may be configured to communicate with the vehicle over a second bus. The second circuit module (i) generates one or more second brake control signals in response to the one or more command inputs and (ii) is powered by a second power source. The second brake control signals provide control of hydraulic flow and pressure applied to a second one or more brake calipers. The first calipers and the second calipers brake different wheels on the vehicle such that braking on at least two wheels of the vehicle operate using only one of the first circuit module or the second circuit module to provide redundant control of the one or more brake calipers.

### FIELD OF THE INVENTION

The invention relates to autonomous vehicles generally and, more particularly, to a method and/or apparatus for implementing a braking system for an autonomous vehicle.

### BACKGROUND

Autonomous vehicles need to implement redundancy on many systems. Conventional autonomous vehicle design has focused on vision systems to prevent collisions. Braking systems have received less design attention. Without a driver initiating a physical movement on a brake pedal, an autonomous vehicle uses electronically generated and transmitted control signals. If one of the components that generates or transmits electronic control signals fails, the vehicle needs to be capable of stopping. In an autonomous braking system, back-up systems and/or redundant systems are needed.

It would be desirable to implement an autonomous vehicle brake system that provides redundancy.

### SUMMARY

The invention concerns an apparatus comprising a first circuit module and a second circuit module. The first circuit module may be configured to communicate with a vehicle over a first bus. The first circuit module (i) generates one or more first brake control signals in response to one or more command inputs and (ii) is powered by a first power source. The first brake control signals provide control of hydraulic flow and pressure applied to a first one or more brake calipers in a vehicle. The second circuit module may be configured to communicate with the vehicle over a second bus. The second circuit module (i) generates one or more second brake control signals in response to the one or more command inputs and (ii) is powered by a second power source. The second brake control signals provide control of hydraulic flow and pressure applied to a second one or more brake calipers. The first calipers and the second calipers brake different wheels on the vehicle such that braking on at least two wheels of the vehicle operate using only one of the first circuit module or the second circuit module to provide redundant control of the one or more brake calipers.

### BRIEF DESCRIPTION OF THE FIGURES

Embodiments of the invention will be apparent from the following detailed description and the appended claims and drawings in which:

FIG. 1 is a diagram of a vehicle implementing an embodiment of the invention;

FIG. 2 is a diagram of an alternate embodiment;

FIG. 3 is a brake topology;

FIG. 4 is a diagram of a functional diagram of the various components;

FIG. 5 is a more detailed diagram of an electronic controller; and

FIG. 6 is a diagram of a hydraulic block.

### DETAILED DESCRIPTION OF THE EMBODIMENTS

Embodiments of the present invention include providing a braking system that may (i) be implemented in an autonomous vehicle environment, (ii) provide redundant control of vehicle brakes, (iii) implement redundant electronic control units having primary and secondary control of a variety of brake configurations and/or (iv) be cost effective to implement.

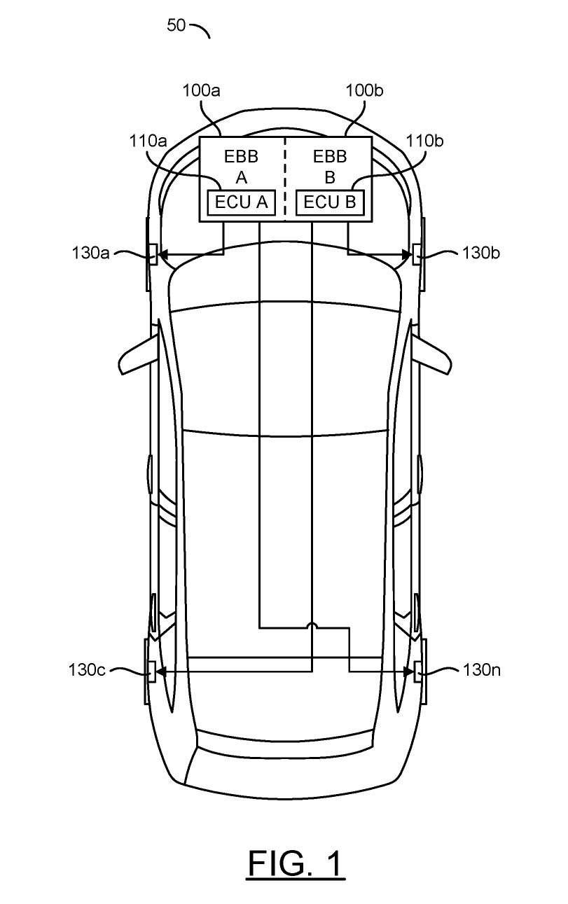

Referring to FIG. 1, a block diagram of a vehicle 50 is shown implementing context of the invention. A block (or unit) 100a and a block (or unit) 100b are shown. The unit 100a may be implemented as a brake control assembly. The unit 100b may be implemented as a brake control assembly. In an example, the unit 100a and the unit 100b may each be implemented as an electronic boosted brake (EBB) system. The brake unit 100a is shown with a block (or circuit) 110a. The brake unit 100b is shown including a block (or circuit) 110b. The circuit 110a may be implemented as an electronic control unit (ECU). The circuit 110b may be implemented as an ECU.

The brake unit 100a is shown connected to a brake caliper 130a and a brake caliper 130n. The brake unit 100b is shown connected to a brake caliper 130b and a brake caliper 130c. The brake unit 100a is shown controlling a left front caliper 130a and a right rear caliper 130n. The brake unit 100b is shown controlling a right front caliper 130b and a left rear caliper 130c. By having one of the brake unit 100a or the brake unit 100b control one of the calipers 130a-130n on each axle of the vehicle 50, and another of the brake units 100a or 100b control another one of the calipers 130a-130n on each axle of the vehicle 50, redundancy is provided. The brake unit 100a or the brake unit 100b generally control hydraulic flow and/or pressure to the calipers 130a-130n. The brake unit 100a and the brake unit 100b are shown located at a front portion of the vehicle 50. In an example, the brake unit 100a and the brake unit 100b may be located on the engine side of a firewall. However, the particular location of the brake unit 100a and/or the brake unit 100b may be varied to meet the design criteria of a particular implementation.

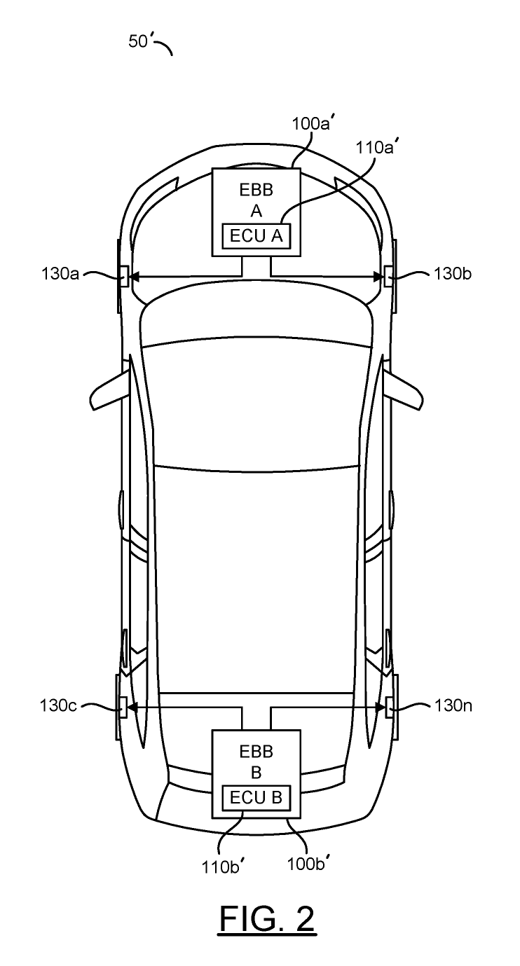

Referring to FIG. 2, a block diagram of a vehicle 50′ is shown. A brake unit 100a′ is shown located in the front portion of the vehicle 50′. The brake unit 100b¹ is shown located in a rear portion of the vehicle 50′. The brake unit 100a′ is shown controlling a left front caliper 130a and a right front caliper 130b. The brake unit 100b′ is shown controlling a left rear caliper 130c′ and a right rear caliper 130b′. By having the brake unit 100a′ control the calipers 130a-130n on one axle of the vehicle 50, and the brake system 100b′ control the calipers 130a-130n on the rear axle of the vehicle 50, redundancy is provided.

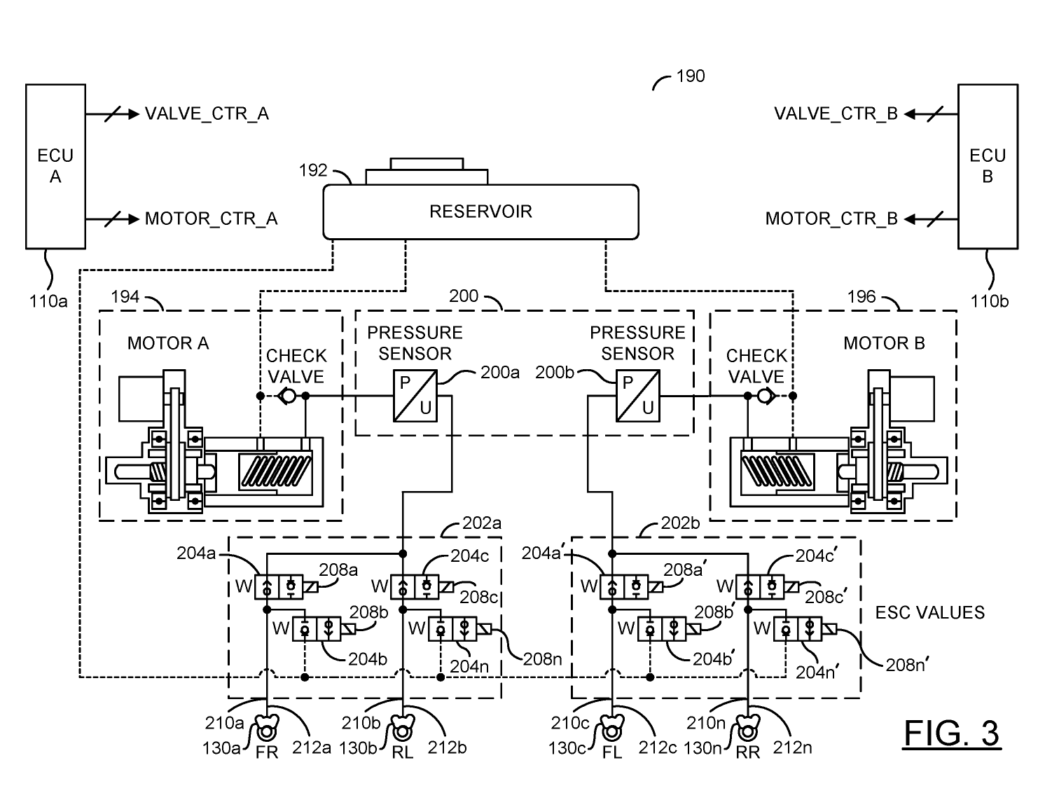

Referring to FIG. 3, a diagram of a topology 190 is shown. The topology 190 generally comprises the ECU 110a, the ECU 110b, a reservoir 192, a motor 194, a motor 196, and a block (or circuit) 200, a section 202a, and a section 202b. The section 202a and the section 202b may be implemented as ESC valve sections. The section 202a includes a number of valves 204a-204n. The valves 204a-204n may each have a plunger (or control pin) 208c-208n. The section 202a generally has a number of outputs 210a and 210b. A number of lines 212a and 212b connect to two of the calipers 130a 130b. The lines 212a and 212b may be implemented as hydraulic brake lines (or hydraulic brake pipes). The section 202b includes a number of valves 204a′-204n′. The valves 204a′-204n′ may each have a plunger (or control pin) 208c′-208n′. The section 202a generally has a number of outputs 210c and 210n. A number of lines 212c and 212n connect to two of the calipers 130c and 130n. The particular two of the calipers 130a-130n the lines 212a and 212b and the lines 212c and 212n connect to may depend on the topology implemented (e.g., FIG. 1, FIG. 2, etc.).

The section 202 may be implemented as a sensor section. The sensor section 200 may include a sensor 200a and a sensor 202b. The sensor 200a and the sensor 202b may be implemented as pressure sensors. In an example, the section 200 may generate a differential signal (not shown) based on a difference between the sensor 200a and a sensor 202b.

The ECU circuit 110a is shown generating a signal (e.g., VALVE_CTR_A) and a signal (e.g., MOTOR_CTR_A). The ECU circuit 110b is shown generating a signal (e.g., VALVE_CTR_B) and a signal (e.g., MOTOR_CTR_B). The signal MOTOR_CTR_A may comprise one or more signals configured to control the motor 194. The signal MOTOR_CTR_B may comprise one or more signals configured to control the motor 196. The signals VALVE_CTR_A and/or VALVE_CTR_B may comprise one or more signals configured to control the valves 204a-204n (or 204a′-204n′). The valves 204a-204n (or 204a′-204n′) generally control operation of the calipers 130a-130n.

The ECU 110a may communicate through a bus (e.g., CAN1) to receive braking control information (e.g., BRAKE_CTR) for the vehicle 50. The ECU 110b may communicate through a bus (e.g, CAN2) to receive braking control information BRAKE_CTR for the vehicle 50. The signal BRAKE_CTR may be received from both the bus CAN1 and the bus CAN2 to provide redundancy. In the example shown in FIG. 3, the motor 194 and the motor 196 may be implemented as hydraulic motors. In an example, the motor 194 and/or 196 may each be implemented as brushless motors or as a DC brush motor/pump unit. The particular type of motor implemented may be varied to meet the design criteria of a particular implementation. The motor/pump unit 194 and/or 196 may provide hydraulic pressure/force to the brake calipers 130a-130n based on control from either of the ECU 110a and/or ECU 110b.

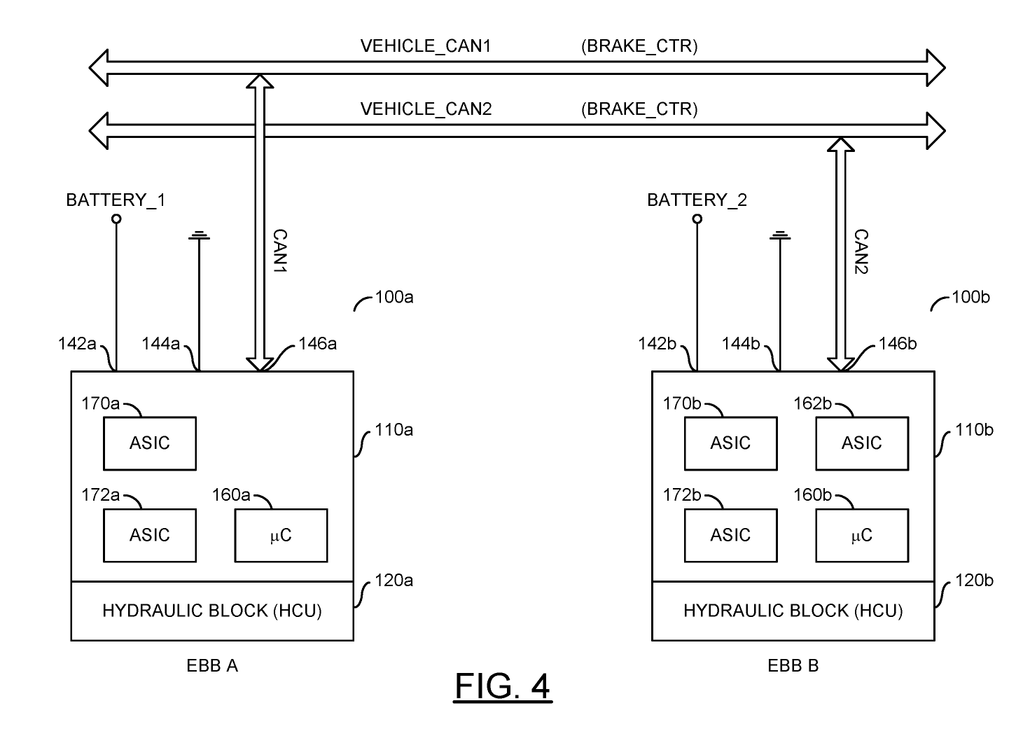

Referring to FIG. 4, a diagram of an example operation is shown. The ECU section 110a is shown having an input 142a, an input 144a, and an input/output 146a. The input 142a may be connected to a power source (e.g., BATTERY_1). The input 144a may be connected to ground. The input/output 146a may be connected to the communication bus CAN1. The ECU section 110b is shown having an input 142b, an input 144b, and an input/output 146b. The input 142b may be connected to a power source (e.g., BATTERY_2). The input 144b may be connected to ground. The input/output 146b may be connected to the communication bus CAN2. The connection to BATTERY_2 may be a redundant connection to a physical battery. In an example, BATTERY_2 may be a back feed connection to a high voltage bus (e.g., a 44v bus).

The input/output 146a may be connected to the bus CAN1. The input/output 146b may be connected to the bus CAN2. One or more command inputs (e.g., shown as the signal BRAKE_CTR) may be received over (i) the bus CAN1 and (ii) the bus CAN2. The command inputs BRAKE_CTR may comprise brake command signals generated by a vehicle logic. The command inputs BRAKE_CTR may be configured to electronically specify an intended level of braking. Separate power (e.g., BATTERY_1 and BATTERY_2) and ground connections are provided for redundancy.

The ECU section 110a generally comprises a block (or circuit) 160a, a block (or circuit) 170a, and a block (or circuit) 172a. The circuit 160a may be implemented as a microprocessor. The circuit 170a may be implemented as an application specific integrated circuit (ASIC). The circuit 172a may be implemented as an ASIC. In an example, the ASIC 170a may control the motor 194 (e.g., a three phase brushless motor). The circuit 172a may be implemented as an ASIC. In an example, the ASIC 172a may implement an electronic stability control (ESC) function. The microcontroller 160a may control one or more of the valves 204a-204n.

The ECU 110b generally comprises a block (or circuit) 160a, a block (or circuit) 160b, a block (or circuit) 170b, and a block (or circuit) 172b. The circuit 160b may be implemented as a microcontroller. The circuit 162b may be implemented as an ASIC. The ASIC 162b may control an electronic parking brake function. In general, only one of the EBB 100a or the EBB 100b needs to control the electronic parking brake function. The circuit 170b may be implemented as an ASIC. The ASIC 170b may control the motor 196 (e.g., a three phase brushless motor). The circuit 172b may be implemented as an ASIC. In an example, the ASIC 172b may implement an electronic stability control (ESC) function. The microcontroller 160b may control one or more of the valves 204a′-204n′.

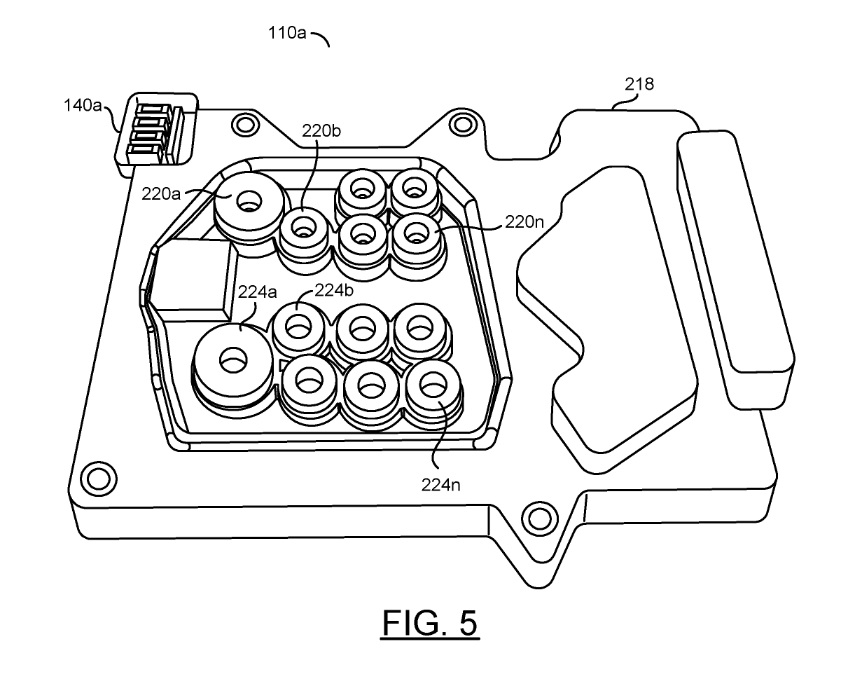

Referring to FIG. 5, a diagram illustrating a more detailed view of the control module 110a is shown. The control module 110b may have a similar implementation. The module 110a is shown connected to a housing 218. The port 140a is shown as an electrical harness. The port 140a may be connected to the bus CANT. Additional connections (not shown) may also be electrically connected to the port 140a. In an example, a connection to a wheel speed sensor may be directly connected to the port 140a. Other direct connections may also be implemented to meet the design criterial of a particular implementation. The port 140b (on the ECU 110b) may have similar connections to provide redundancy.

The module 110a is shown with a plurality of coils 220a-220n and a plurality of coils 224a-224n. The coils 220a-220n may be connected to an ASIC circuit (not shown). The coils 220a-220n and the coils 224a-224n may control the valves 204a-204n. The coils 224a-224n may be connected to ASIC circuit (not shown). The module 110b may have similar connections.

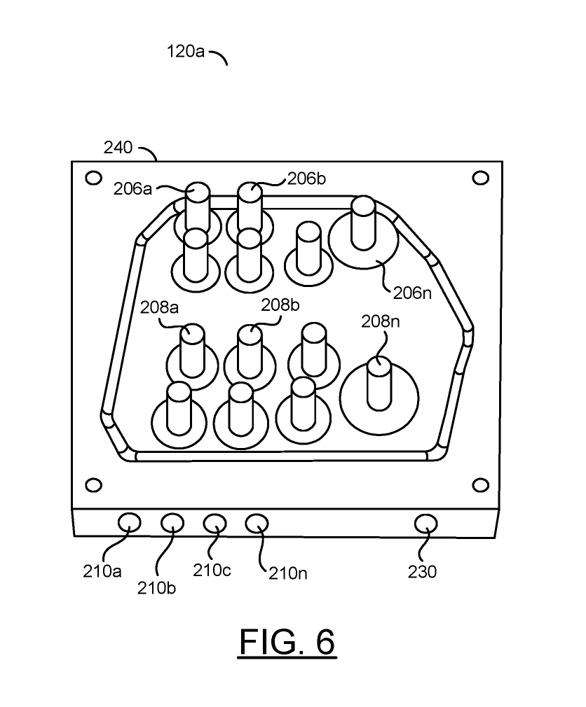

Referring to FIG. 6, a more detailed diagram of the hydraulic block (or hydraulic control unit (HCU)) 120a is shown. The hydraulic block 120a is shown including a casing 240, a plurality of pins 206a-206n and a plurality of pins 208a-208n. The pins 206a-206n may be configured to physically interconnect with the coils 220a-220n. The pins 208a-208n may be configured to physically interconnect with the coils 224a-224n. The various coils 220a-220n and/or 226a-226n control the operation of the various valves 206a-206n. The control generally responds to the signal VALVE_CTR generated by the controller 110a.

Each of the valves 204a-204n may include a valve body and a respective pin (or plunger) 208a-208n. The valves 204a-204n may be implemented as hydraulic valves. The plungers 208a-208n may open or close depending on the state of the coils 220a-220n and/or 224a-224n. When one of the coils 220a-220n and/or 224a-224n energizes (or actuates), a respective plunger 208a-208n either closes a path to stop oil from flowing, or opens a path allowing oil to flow. Various types of hydraulic valves may be implemented to meet the design criteria of a particular implementation. The valves 204a-204n generally have an inlet and outlet. In an example, a 3-way valve may be implemented.

The coils 220a-220n and/or 224a-224n may have a 2-pin connection to receive the signals VALVE_CTRa and/or MOTOR_CTRa from the ECU circuit 110a. The pins provide an electrical connection to a PCB (not shown). The coils 220a-220n and/or 224a-224n may be connected to the PCB 152 using pressfit technique. The coils 220a-220n and/or 224a-224n physically surround the respective plungers 206a-206n and/or 208a-208n. The plungers 206a-206n and/or 208a-208n physically move inside the respective valve body. When one of the coils 220a-220n and/or 224a-224n is energized, a magnetic field moves a respective one of the plungers 208a-208n. The plungers 208a′-208n′ may have a similar operation.

The motor 194 and the motor 196 may operate to control the hydraulic flow and/or pressure applied to the brake calipers 130a-130n during normal operation. In a redundancy (or failover) condition, either the motor 194 or the motor 196 (and corresponding valves 204a-204n or valves 204a′-204n′) provide control to a minimum number of the calipers 130a-130n to stop the vehicle 50.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a first circuit module configured to communicate with a vehicle over a first bus, wherein said first circuit module (i) generates one or more first brake control signals in response to one or more command inputs, (ii) is powered by a first power source and (iii) said first brake control signals provide control of hydraulic flow and pressure applied to a first one or more brake calipers in a vehicle; and
a second circuit module configured to communicate with said vehicle over a second bus, wherein (A) said second circuit module (i) generates one or more second brake control signals in response to said one or more command inputs, (ii) is powered by a second power source and (iii) said second brake control signals provide control of hydraulic flow and pressure applied to a second two or more brake calipers, and (B) said first calipers and said second calipers brake different wheels on said vehicle such that braking on at least two wheels of said vehicle operate using only one of said first circuit module or said second circuit module to provide redundant control of said one or more brake calipers.

2. The apparatus according to claim 1, further comprising:
a first hydraulic actuator (i) configured to control said first brake calipers in response to said first brake control signals and (ii) physically connected to said first circuit module; and
a second hydraulic actuator (i) configured to control said second brake calipers in response to said second brake control signals and (ii) physically connected to said second circuit module, wherein said first brake control signals and said second brake control signals are independently generated to provide redundancy in an autonomous vehicle.

3. The apparatus according to claim 2, wherein:
said first circuit module and said first hydraulic actuator form a first electronic boosted brake (EBB) system; and
said second circuit module and said second hydraulic actuator form a second electronic boosted brake (EBB) system, wherein said first electronic boosted brake system and said second electronic boosted brake system operate independently.

4. The apparatus according to claim 3, wherein said first electronic boosted brake system and said second electronic boosted brake system are mounted in a front portion of said vehicle.

5. The apparatus according to claim 4, wherein (i) said first electronic boosted brake system controls one brake caliper on a front axle and one brake caliper on a rear axle of said vehicle and (ii) said second electronic boosted brake system controls one brake caliper on a front axle and one brake caliper on a rear axle of said vehicle.

6. The apparatus according to claim 3, wherein (i) said first electronic boosted brake system is mounted in a front portion of said vehicle and (ii) said second electronic boosted brake system is mounted in a rear portion of said vehicle.

7. The apparatus according to claim 3, wherein (i) said first electronic boosted brake system (a) is mounted near a front axle of said vehicle and (b) controls brake calipers on said front axle (ii) said second electronic boosted brake system is near a rear axle of said vehicle and (b) controls brake calipers on said rear axle.

8. The apparatus according to claim 1, wherein said command inputs (i) comprise brake command signals generated by a vehicle logic and (ii) are configured to electronically specify an intended level of braking.

9. The apparatus according to claim 8, wherein said command inputs are received over (i) said first bus and (ii) said second bus.

10. The apparatus according to claim 2, wherein said first and second brake control signals control said actuation of said hydraulic brake lines by energizing one or more valves.

11. The apparatus according to claim 10, wherein said hydraulic brake lines control the operation of said one or more brake calipers on said vehicle.

12. The apparatus according to claim 11, wherein said brake signals are electrically connected to said first and second hydraulic blocks through one or more press pin connections.

13. The apparatus according to claim 1, wherein said apparatus is implemented in an autonomous vehicle.
